(19) United States
(12) Patent Application Publication
(10) Pub. No.: US 2020/0331240 A1
(43) Pub. Date: Oct. 22, 2020

(54) LAMINATE AND METHOD FOR MAKING THE SAME

(71) Applicant: INDUSTRIAL LAMINATES/NORPLEX, INC., POSTVILLE, IA (US)

(72) Inventor: Kevin L. BRAINARD, Monona, IA (US)

(21) Appl. No.: 16/848,006

(22) Filed: Apr. 14, 2020

Related U.S. Application Data
(60) Provisional application No. 62/834,552, filed on Apr. 16, 2019.

(51) Int. Cl. B32B 25/08; B32B 25/06; B32B 17/02; B32B 5/02; B32B 29/00; B32B 37/10; B32B 27/38; B32B 7/12; B32B 37/16

(52) U.S. Cl. CPC B32B 25/08; B32B 25/06; B32B 17/02; B32B 5/02; B32B 29/002; B32B 37/10; B32B 2305/08; B32B 7/12; B32B 37/16; B32B 2250/42; B32B 2262/101; B32B 2309/025; B32B 2309/04; B32B 27/38

(57) ABSTRACT

A laminate blank includes at least one rigidifying layer and at least one comfort layer. The rigidifying layer includes a reinforcement preform and a resin. The layers are pressed to form the laminate blank.

### PRIORITY CLAIM

This application claims the benefit, under 35 U.S.C. § 119(e), to U.S. Provisional Application No. 62/834,552, filed Apr. 16, 2019, the contents of which is incorporated by reference in its entirety into the present application.

### BACKGROUND

The present disclosure relates to blanks, and particularly to blanks used to manufacture other components. More particularly, the present disclosure relates to a laminate blank.

### BRIEF DESCRIPTIONS OF THE DRAWINGS

The detailed description particularly refers to the accompanying figures in which:

FIG. 1 is a perspective view of a laminate blank that can be used to manufacture other components such as a grip as shown in FIGS. 1A and 1B;

FIG. 1A is a perspective view of a grip manufactured from the laminate blank in FIG. 1;

FIG. 1B is a perspective view of another grip manufactured from the laminate blank in FIG. 1;

FIG. 2 is a sectional view taken along line 2-2 of FIG. 1, showing that the molded blank includes a plurality of prepreg layers interlaid between a plurality of rubber layers;

FIG. 3 is a diagrammatic dead-section view of a method of manufacturing a laminate blank, showing from top to bottom, a step preparing a pre-laminate book by stacking layers of prepreg and rubber, a step of applying caul plates and press pads and positioning the pre-laminate book with the caul plates and press pads on a pressing machine, a step of pressing the pre-laminate book and processing the pre-laminate book in the press machine through a press cycle to form the laminate blank, and a step of manufacturing a grip from the laminate blank;

FIGS. 4A and 4B are perspective views of other types of grips manufactured from the laminate blank in accordance with the present disclosure;

FIG. 5 is a sectional and diagrammatic view similar to FIG. 2, of a first embodiment of a pre-laminate book in accordance with the present disclosure;

FIG. 6 is a sectional and diagrammatic view similar to FIGS. 2 and 5, showing another embodiment of a pre-laminate book in accordance with the present disclosure and showing a bonding layer included between each layer of prepreg and rubber;

FIG. 7 is a sectional and diagrammatic view of the first embodiment of the pre-laminate book with caul plates and press pads applied and a PET release layer located between pre-laminate book and the caul plates and press pads;

FIG. 8 is a sectional and diagrammatic view of a third embodiment of a pre-laminate book with caul plates and press pads applied and a silicone release layer located between the pre-laminate book and the caul plates and press pads;

FIG. 9 is sectional and diagrammatic view of a fourth embodiment of a pre-laminate book with caul plates and press pads applied and a vegin release layer located between the pre-laminate book and the caul plates and press pads;

FIG. 10 is sectional and diagrammatic view of a fifth embodiment of a pre-laminate book with caul plates and press pads applied and a silicone release layer located between the pre-laminate book and the caul plates and press pads;

FIG. 11 is a perspective view of a pre-laminate book with a plurality of prepreg layers and rubber layer misaligned with one another to show how different numbers of prepreg and rubber may be used together to form a pre-laminate book with user desired structure, color, and thickness;

FIG. 12 is a perspective view of a pre-laminate book being placed in a pressing machine that is configured to process the pre-laminate book through a press cycle to produce a laminate blank;

FIG. 13 is a perspective view of a finished laminate blank after being processed through the press cycle; and

FIG. 14 is an enlarged perspective view of a portion of the finished laminate blank in FIG. 13 showing the different layers of prepreg and rubber that make up the laminate.

### DETAILED DESCRIPTION

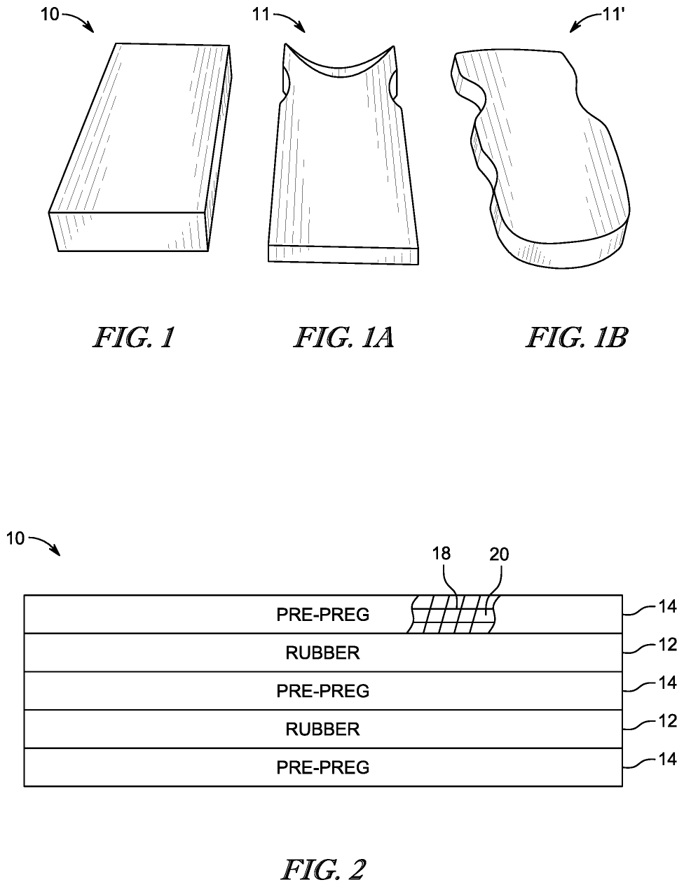

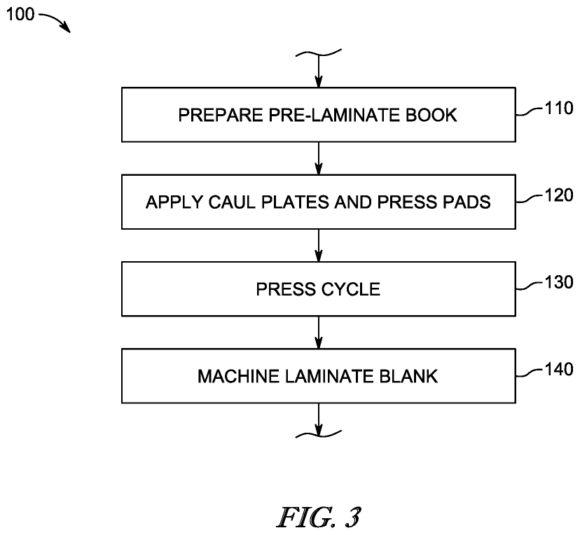

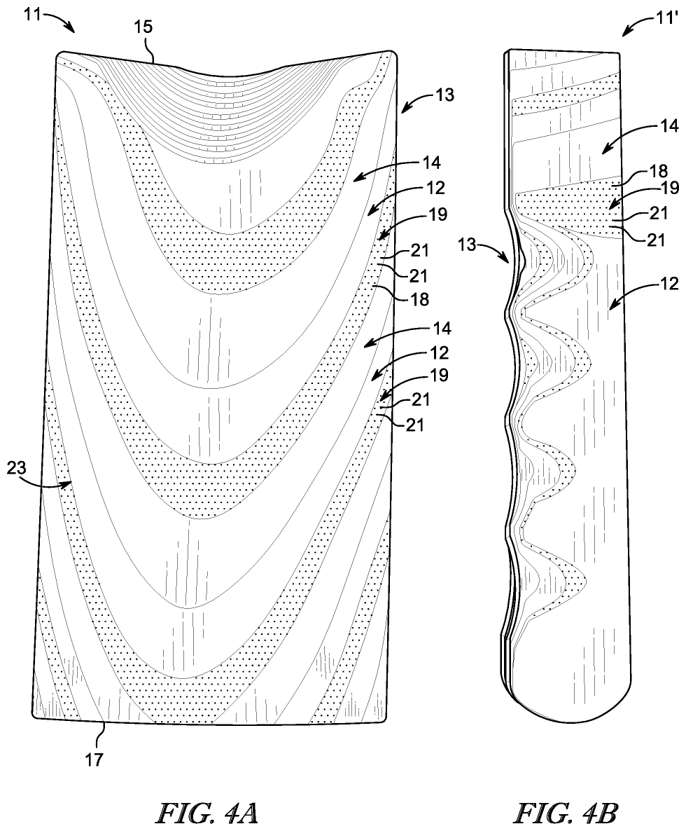

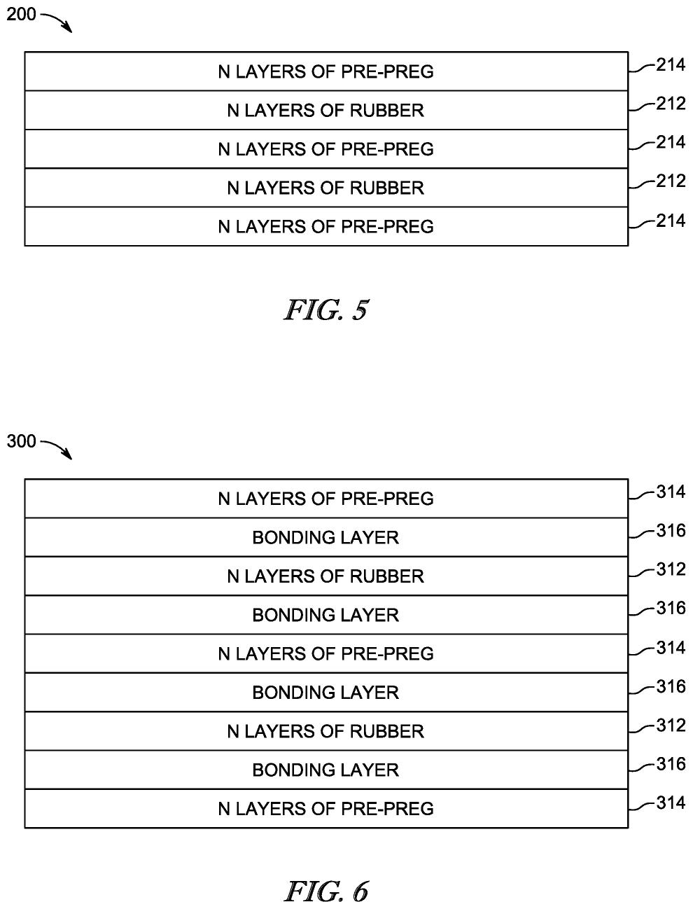

A laminate blank 10, in accordance with the present disclosure, for use in manufacturing other components, such as, for example, grips 11, 11′, is shown in FIGS. 1-1B. The laminate blank 10 may be worked to form a grip 11, 11′ for handheld devices as shown in FIGS. 1A, 1B, 4A, and 4B, such as, for example, a knife, handgun, bow, or another device held by hand. A method for forming the laminate blank 10 is shown in FIG. 3. Additional embodiments of molded blanks 210, 310, 410, and 510 are shown in FIGS. 5-10.

The laminate blank 10 illustratively includes a plurality of ergonomic-comfort layers 12 (also called rubber layers 12) interlaid between a plurality of rigidifying-support layers 14 (also called prepreg layers 14) that are stacked to provide a block as shown in FIG. 2. In other embodiments, the rubber 12 and the prepreg 14 may be joined to one another to produce another suitable structure such as, for example, a plate, a rod, or a tube. The rubber layers 12 are relatively flexible and have a greater coefficient of friction than the prepreg layers 14. The prepreg layers 14 rigidify the laminate blank 10 so that the laminate blank 10 may be manufactured in to a grip and used in applications where the laminate is subjected to forces during use. Depending on the type of prepreg 14 used, the laminate blank 10 may optionally include a bonding layer 16 to increase bonding between the rubber layers 12 and the prepreg layers 14.

The laminate blank 10 may be customized to user preferences for aesthetics and comfort. For example, the laminate 10 may have any desired color and/or patterns of colors provided by the rubber 12 and prepreg layers 14. Additionally, the laminate blank 10 may have any suitable thickness to fit the hand of any given user by adding or removing layers of rubber 12 and prepreg 14 until a desired overall thickness of the laminate blank 10 is reached. The laminate blank 10 may include any number of rubber layers 12 and prepreg layers 14 to change the stiffness of the laminate blank 10. Generally, an increased number of rubber layers 12 coincides with a lower stiffness while an increased number of prepreg layers 14 coincides with a higher stiffness.

In one example, the rubber layers 12 includes a 0.041-inch thick Tan Buna 68 Duro ply that is about 40.5 inches long by about 80.5 inches wide. In another example, the rubber layers 12 include a 0.040-inch thick Tan Buna 65 Duro ply that is about 40.5 inches long by about 80.5 inches wide. In another example, the rubber layers 12 include a 0.015-inch thick Red Buna N ply that is about 40 inches long by about 80 inches wide. In another example, the rubber layers 12 include a 0.031-inch thick Red Buna N ply that is about 40 inches long by about 80 inches wide. In another example, the rubber layers 12 include a 0.020-inch thick Red Buna N ply that is about 40.5 inches long by about 80.5 inches wide. In another example, the rubber layers 12 include a 0.046-inch thick Red Buna N ply that is about 40.5 inches long by about 80.5 inches wide. In another example, the rubber layers 12 include a 0.015-inch thick Black Buna N ply that is about 50.5 inches long by about 124.5 inches wide. In another example, the rubber layers 12 include a 0.015-inch thick Black Buna N ply that is about 40.5 inches long by about 80.5 inches wide. In another example, the rubber layers 12 include a 0.015-inch thick Red Buna N ply that is about 40.5 inches long by about 80.5 inches wide. In another example, the rubber layers 12 include a 0.025-inch thick Red Buna N ply that is about 40.5 inches long by about 80.5 inches wide. In another example, the rubber layers 12 include a 0.031-inch thick Red Buna N ply that is about 40.5 inches long by about 80.5 inches wide. In another example, the rubber layers 12 include a 0.062-inch thick Red Buna N ply that is about 40.5 inches long by about 80.5 inches wide. In another example, the rubber layers 12 include a 0.032-inch thick Tan Buna N ply that is about 40.5 inches long by about 80.5 inches wide. In another example, the rubber layers 12 include a 0.031-inch thick Black Buna ply that is about 40.5 inches long by about 80.5 inches wide. In another example, the rubber layers 12 include a 0.036-inch thick Black Buna ply that is about 50 inches long by about 40 inches wide. In another example, the rubber layers 12 may have other colors.

In other examples, the rubber layers 12 may include Neoprene, Buna-N (also called nitrile, acrylonitrile, and NBR), Silicone (also called polysiloxane), EPDM, Natural Gum, Viton (also called FKM), Natural Latex, SBR (also called styrene butadiene), Vinyl (also called polyvinyl chloride), Santoprene, epichlorohydrin (ECH), Butyl (also called isobutylene isoprene), Latex-Free TPE, and/or Hypalon (also called chlorosulfonated polyethylene). In other examples, the rubber layers 12 may include combinations of the plies and materials described above.

The prepreg layers 14 include a reinforcement preform 18 and a resin 20 meshed with the reinforcement preform 18 as shown in FIG. 2. The reinforcement preform 18 includes composite fibers that are woven or braided together and then preimpregnated with the resin 20 to provide a reinforced thermoset plastics layer (i.e. prepreg 14). In some embodiments, the reinforcement preform 18 includes at least one of fiberglass (i.e. G10), canvas, linen, paper, or combinations thereof. In some embodiments, the resin 20 includes at least one of an epoxy, phenolic, melamine, or a combination thereof.

In one embodiment, the prepreg layers 14 include one of the following grades: SE4GW02, SP1NW01, or SP2NW02 available from Norplex-Micarta located in Postville, Iowa. In another embodiment, combinations of prepreg layers 14 with the grades listed above may be used.

Some types of reinforcement preforms 18 may use a bonding layer 16 between each rubber/prepreg interface to increase bonding between the prepreg layers 14 and the rubber layers 12. In the illustrative embodiment, a suitable bonding layer 16 is item number 405544 manufactured by Norplex-Micarta located in Postville, Iowa.

An illustrative method 100 of forming the laminate blank 10 described above is shown in FIG. 3. The method begins with a step 110 where a user prepares a pre-laminate book that is later formed into the laminate blank 10 through a press cycle 130 as will be described. Preparing the pre-laminate book includes selecting a color or pattern of colors. In the illustrative embodiment, the rubber layers 12 and the preform layers 14 may include any desired color or pattern of colors. For example, the rubber layers 12 may include a black color while the prepreg layers 14 include a yellow color to provide a stripped pattern with alternating layers of black rubber 12 and yellow prepreg 14. In other embodiments, the laminate blank 10 may include multiple layers of rubber 12 or prepreg 14 with different colors.

The step 110 of preparing the pre-laminate book continues with the user selecting a desired thickness for the laminate blank 10. As described above, the thickness is a function of the number of layers of both rubber 12 and prepreg 14 and can be altered by adding or removing layers. Alternatively, the rubber layers 12 and/or the prepreg layers 14 may be preselected based on the relative thickness of each individual layer and combined to reach a desired overall thickness. The step 110 may further include applying a bonding layer 16 between each interface between a rubber layer and a prepreg layer 14 depending on the type of prepreg layer used.

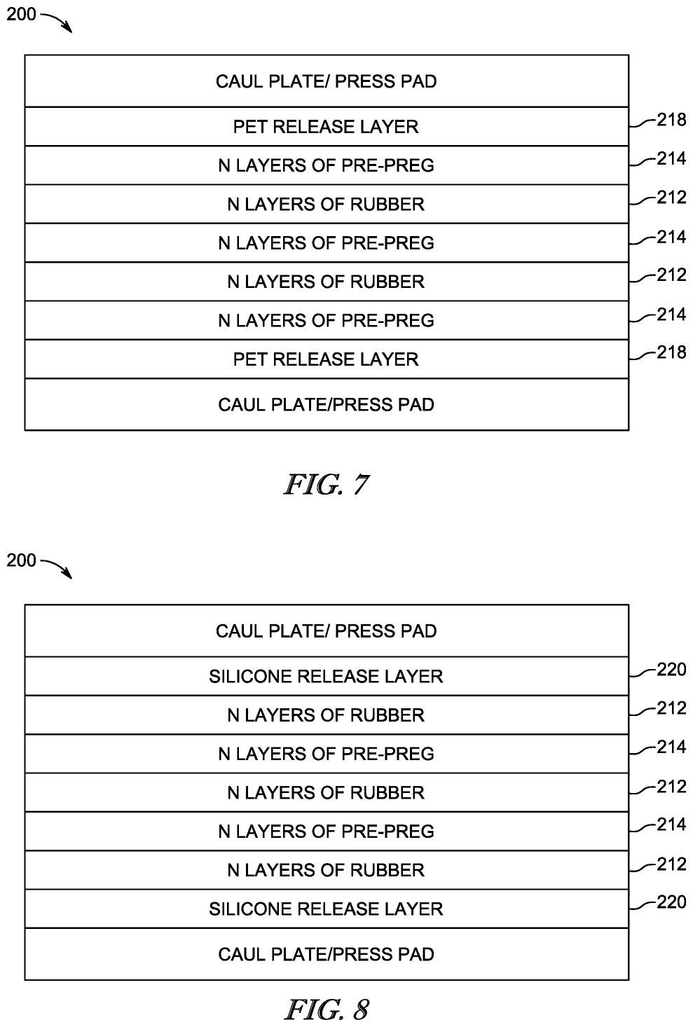

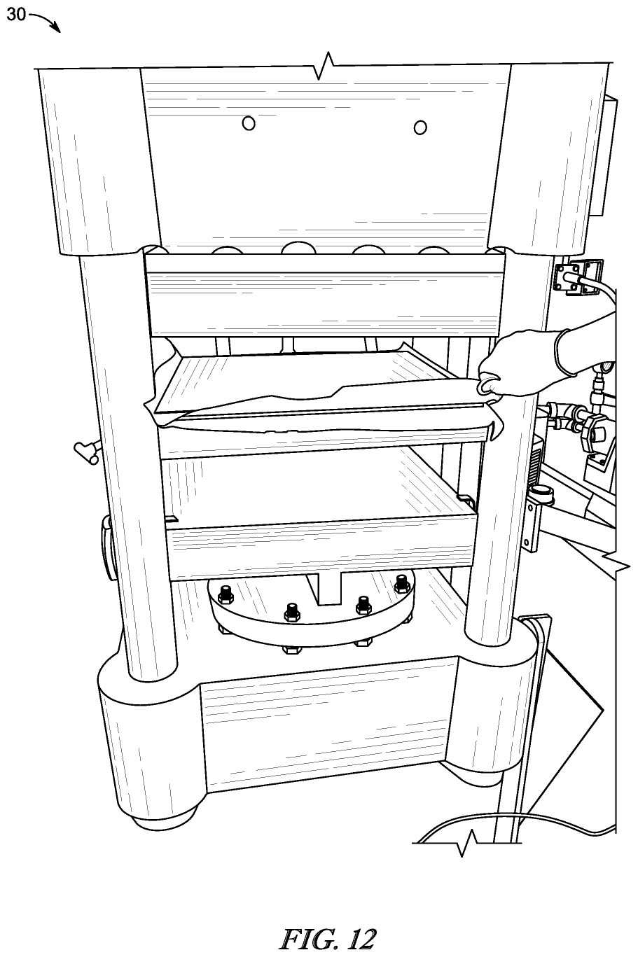

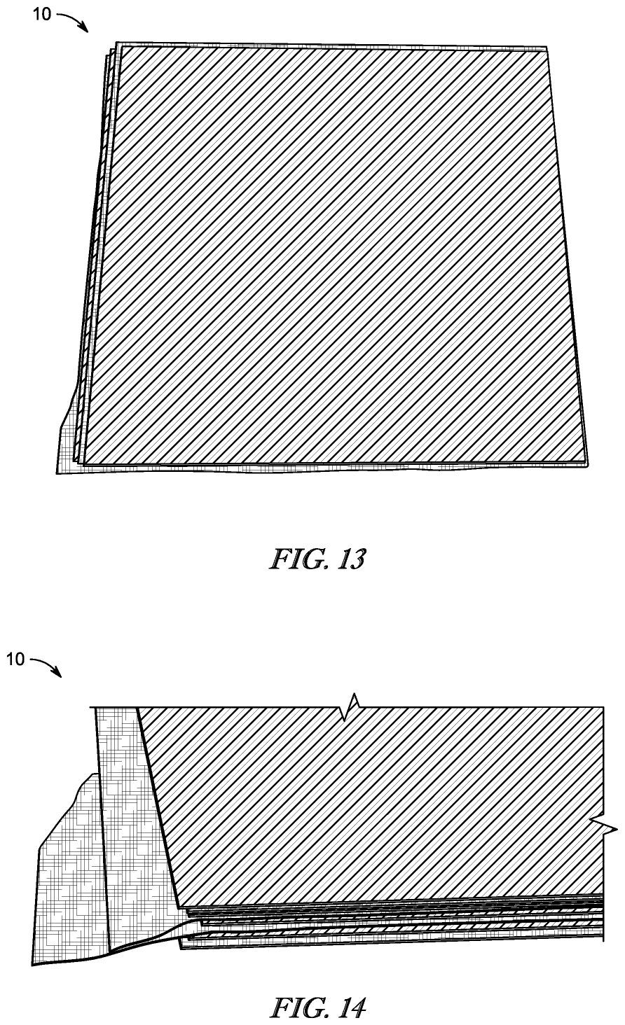

The method continues with a step 120 of applying caul plates, press pads and/or release layers (see FIGS. 7-10) over the pre-laminate book prior to the pre-laminate book being readied for the press cycle 130. The caul plates include a metallic material that is placed over the last layer on each side of the pre-laminate book to protect the caul plates during the press cycle 130. The press pads include non-metallic material and are placed over an outer surface of each caul plate relative to the pre-laminate book. The pre-laminate book, along with the caul plates and the press pads, is the placed in a pressing machine 30 (See FIG. 12) and readied for the press cycle 130. The pressing machine is illustratively a hot press machine that is able to apply at least 450 psi on the pre-laminate book and provide heating and cooling within a range of about 50 degrees Fahrenheit (F) to about 350 degrees F.

The press cycle 130 includes a series of heating steps and cooling steps to form the laminate blank 10 as shown in FIG. 4. The press cycle 130 begins with pre-heating the pressing machine to a temperature within a range of about 225 degrees F. to about 275 degrees F. The pre-laminate book is then placed in the pressing machine with the caul plates, press pads and/or release layers for pressing. More than one pre-laminate book may be pressed at a time depending on the size of the pressing machine and the size of the pre-laminate book being pressed. In the illustrative embodiment, the pressing machine is configured to apply a pressure within a range of about 325 psi to about 475 psi throughout the press cycle 130. In the illustrative embodiment, the pressure remains constant; however in other embodiments the pressure may vary during the press cycle 130.

The press cycle 130 continues with pressing the pre-laminate book at a temperature within a range of about 225 degrees F. to about 275 degrees F. for an amount of time within a range of about 10 minutes to about 20 minutes. The pre-laminate book is then pressed at a temperature within a range of about 300 degrees F. to about 325 degrees F. for an amount of time within a range of about 40 minutes to about 50 minutes. The pre-laminate is then pressed at a temperature within a range of about 275 degrees F. to about 300 degrees F. for an amount of time within a range of about 10 minutes to about 15 minutes. The pre-laminate book is then pressed at a temperature of less than about 100 degrees F. for an amount of time within a range of about 20 minutes to about 30 minutes. Once these steps are completed, the pre-laminate book is now the laminate blank 10 and the laminate blank 10 may then be machined at a step 140 to form various items such as grips 11, 11′ as shown in FIGS. 4A and 4B.

The illustrative handgrips 11, 11′ shown in FIGS. 4A and 4B were formed from a laminate blank 10 including the plurality of prepreg layers 12 and the plurality of the rubber layers 14 that have been fully processed through method 100. The handgrips 11, 11′ are each formed to include contours 13 that coincide with a hand of a user to provide an ergonomic handgrip. The contours 13 are defined by both prepreg layers 12 and rubber layers 14 which overlap one another and have varying lengths between an upper edge 15 and an a lower edge 17 of the handgrips 11, 11′. The prepreg layers 12 and the rubber layers 14 may also vary in width along their length so that each have a curvilinear shape or u-shape. The rubber layers 14 may combine with one or more of the prepreg layers 14 to provide transition layers 19 between the rubber layers 14 and the prepreg layers 12. Within the transition layers 19, portions of the rubber layers 14 extend into voids formed between the fibers 18 of the prepreg layers 12 to provide nodes 21 of rubber. The nodes 21 may be interlaid in the fibers 18 of the prepreg layers once fully processed to bond the rubber layers 14 with the prepreg layers 12 and provide the handgrip 11, 11′. The nodes 21 may protrude through the fibers 18 to partially define an outer surface 23 of the handgrip 11, 11′.

Some examples of pre-laminate books prior to being readied for the press cycle 130 are shown diagrammatically in FIGS. 5 and 6. A first embodiment of a pre-laminate book 200 is shown in FIG. 5. The pre-laminate book 200 includes alternating layers of rubber 212 and prepreg 214. The pre-laminate book 200 may include any number of layers rubber 212 and any number of layers of prepreg 214. In the illustrative embodiment, the rubber 212 is one of the types described above and the prepreg 214 includes a fiberglass reinforcement preform and an epoxy resin.

A second embodiments of a pre-laminate book 300 is shown in FIG. 6. The pre-laminate book 300 includes alternating layers of rubber 312, prepreg 314 and bonding layers 316. The pre-laminate book 300 may include any number of layers rubber 312 and any number of layers of prepreg 314. In the illustrative embodiment, the rubber 312 is one of the types described above and the prepreg 314 includes a canvas, linen, or paper reinforcement preform and a phenolic resin. At least one bonding layer 316 is positioned between each rubber/prepreg interface.

Some examples of pre-laminate books readied for the pressing cycle 130 are shown in FIGS. 7-10. The first embodiment of the pre-laminate book 200 is loaded with release layers 218, 220 on each end of the prepreg book 200 between the caul plates/press pads and the pre-laminate book 200 as shown in FIGS. 7 and 8. If the pre-laminate book has a prepreg outermost layer 214, a Polyethylene terephthalate (PET) release layer 218 is positioned between the prepreg book 200 and the caul plates/press pads as shown in FIG. 7. If the pre-laminate book 200 has a rubber outermost layer 212, a silicone release layer 220 is positioned between the prepreg book 200 and the caul plates/press pads as shown in FIG. 8.

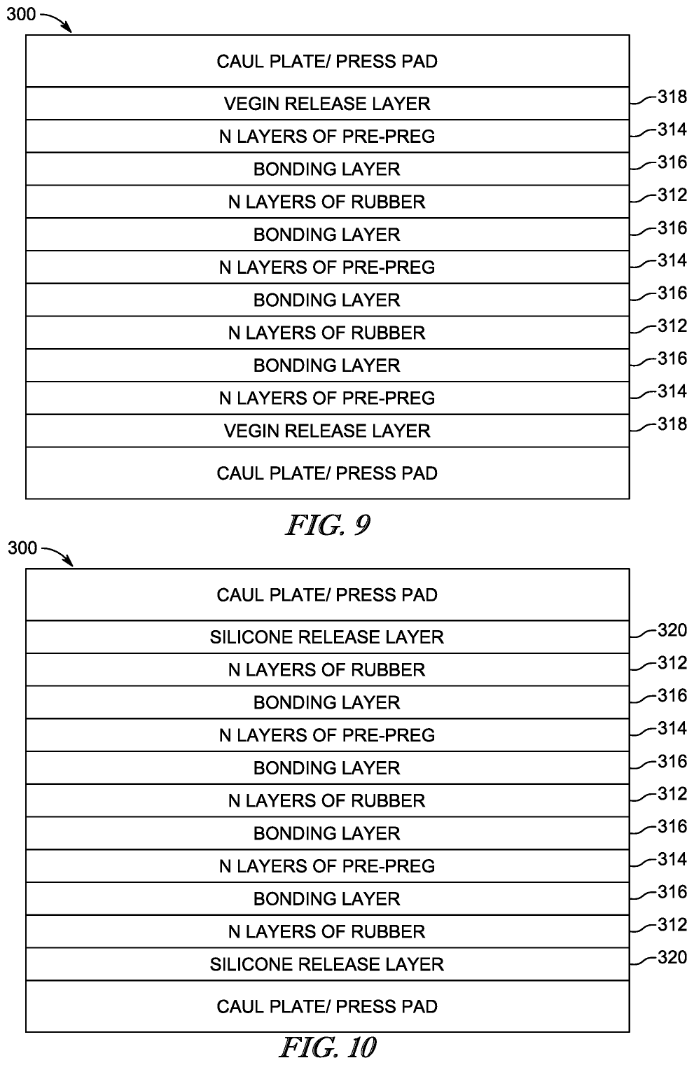

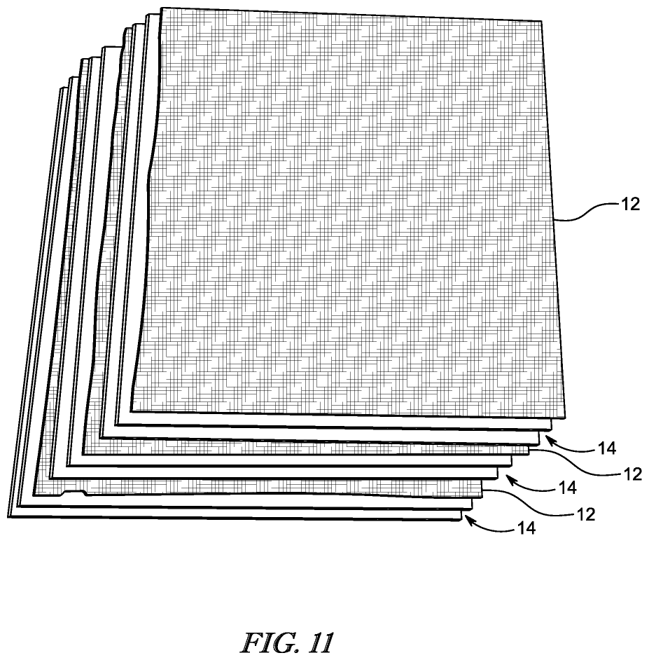

The second embodiment of the pre-laminate book 300 is loaded with release layers 318, 320 on each end of the prepreg book 300 between the caul plates/press pads and the pre-laminate book 300 as shown in FIGS. 9 and 10. If the pre-laminate book 300 has a prepreg outermost layer 314 that includes a phenolic resin, a vegin release layer 318 is positioned between the prepreg book 200 and the caul plates/press pads as shown in FIG. 9. If the pre-laminate book 200 has a rubber outermost layer 212, a silicone release layer 220 is positioned between the prepreg book 200 and the caul plates/press pads as shown in FIG. 10.

1. A handgrip comprising
a plurality of prepreg layers including a reinforcement preform and a resin,
at least one rubber layer interlaid between the plurality of prepreg layers, and
a plurality of contours that expose portions of the plurality of prepreg layers and the at least one rubber layer.

2. The handgrip of claim 1, wherein the handgrip has a first edge and an opposite second edge and at least a portion of each of the prepreg layers have lengths between the first and second edges that are different from one another.

3. The handgrip of claim 2, wherein at least a portion of the at least one rubber layer has a length between the first and second edges that is different from each of the plurality of prepreg layers.

4. The handgrip of claim 1, wherein at least one of the plurality of prepreg layers is combined with the at least one rubber layer to provide a transition layer that includes a plurality of nodes of rubber that extend into voids between fibers of the at least one prepreg layer.

5. The handgrip of claim 4, wherein some of the nodes partially define an outer surface of the handgrip.

6. The laminate blank of claim 1, wherein the reinforcement preform of the plurality of prepreg layers includes one of fiberglass, canvas, linen, and paper.

7. The laminate blank of claim 1, wherein the resin of the plurality of prepreg layers includes one of epoxy and phenolic.

8. The laminate blank of claim 1, further comprising a bonding layer positioned at an interface between prepreg layer and rubber layer.

9. The laminate blank of claim 8, wherein the bonding layer includes phenolic.

10. A laminate blank comprising
a plurality of prepreg layers including a reinforcement preform and a resin, and
at least one rubber layer interlaid between the plurality of prepreg layers.

11. The laminate blank of claim 10, wherein the plurality of prepreg layers have a first color and the at least one rubber layer has a second color different than the first color.

12. The laminate blank of claim 10, wherein the reinforcement preform of the plurality of prepreg layers includes one of fiberglass, canvas, linen, and paper.

13. The laminate blank of claim 10, wherein the resin of the plurality of prepreg layers includes one of epoxy and phenolic.

14. The laminate blank of claim 10, further comprising a bonding layer positioned at an interface between prepreg layer and rubber layer.

15. The laminate blank of claim 14, wherein the bonding layer includes phenolic.

16. A method of forming a laminate blank, the method comprising
preparing a pre-laminate book including a plurality of prepreg layers and a plurality of rubber interlaid between the prepreg layers,
applying caul plates and press pads to the outermost layers of the pre-laminate book, and
processing the pre-laminate book through a press cycle.

17. The method of claim 16, wherein the processing includes pressing the pre-laminate book at a temperature within a range of about 225 degrees F. to about 275 degrees F. for an amount of time within a range of about 10 minutes to about 20 minutes.

18. The method of claim 17, wherein the processing includes pressing the pre-laminate book at a temperature within a range of about 300 degrees F. to about 325 degrees F. for an amount of time within a range of about 40 minutes to about 50 minutes.

19. The method of claim 18, wherein the processing includes pressing the pre-laminate book at a temperature within a range of about 275 degrees F. to about 300 degrees F. for an amount of time within a range of about 10 minutes to about 15 minutes.

20. The method of claim 19, wherein the processing includes pressing the pre-laminate book at a temperature of less than about 100 degrees F. for an amount of time within a range of about 20 minutes to about 30 minutes.
